(19) United States
(12) Patent Application Publication
(10) Pub. No.: US 2024/0239171 A1
(43) Pub. Date: Jul. 18, 2024

(54) ELECTRIC VEHICLE

(71) Applicant: Il-hong MIN, Pocheon-si (KR)

(72) Inventor: Il-hong MIN, Pocheon-si (KR)

(21) Appl. No.: 18/289,870

(22) PCT Filed: Apr. 27, 2022
(86) PCT No.: PCT/KR2022/006004

§ 371 Date: Nov. 7, 2023

(30) Foreign Application Priority Data
May 10, 2021 (KR) 10-2021-0059687

(51) Int. Cl. B60K 1/02; B60K 17/02; B60K 17/16

(52) U.S. Cl. CPC B60K 1/02; B60K 17/02; B60K 17/16

(57) ABSTRACT

The present invention relates to an electric vehicle and provides an electric vehicle including a main motor configured to generate a driving force, a sub-motor configured to share a rotational shaft with the main motor, and a gear unit positioned between a differential gear provided on a driving shaft and the main motor, wherein the main motor has fixed power applied after operated, and the gear unit has a gear ratio varying depending on the manipulation of an accelerator pedal, and since the main motor maintains a relatively lower rotation during traveling at a high speed, it is possible to prevent energy efficiency from being sharply reduced during traveling at a high speed.

### TECHNICAL FIELD

The present invention relates to an electric vehicle, and more specifically, to an electric vehicle capable of preventing energy efficiency from being sharply reduced even when traveling at a high speed.

### BACKGROUND ART

Hybrid electric vehicles are driven by a motor when traveling at a low speed and driven by an internal combustion engine when traveling at a high speed. This is because the motor has high energy efficiency when the vehicle travels at a low speed, and the internal combustion engine has high energy efficiency when the vehicle travels at a high speed.

On the other hand, since electric vehicles are not equipped with the internal combustion engine, there has been a regret that energy efficiency is sharply reduced during traveling at a high speed.

### Technical Problem

In consideration of this point, the present invention is directed to providing an electric vehicle capable of preventing energy efficiency from being sharply reduced even when traveling at a high speed.

### Technical Solution

In order to achieve the object, an electric vehicle according to one embodiment of the present invention includes a main motor configured to generate a driving force, a sub-motor configured to share a rotational shaft with the main motor, and a gear unit positioned between a differential gear provided on a driving shaft and the main motor, wherein the main motor has fixed power applied after operated, and the gear unit has a gear ratio varying depending on the manipulation of an accelerator pedal.

In addition, the sub-motor may have applied power varying depending on a change in speed and an inclination of the ground.

In addition, when the power applied to the sub-motor is zero, the sub-motor may generate power by a rotational force of the rotational shaft.

In addition, the gear unit may have a gear ratio varying depending on a change in speed and an inclination of the ground.

In addition, the gear unit may have a continuously variable transmission (CVT) structure.

In addition, a clutch may be provided between the gear unit and the main motor.

### Advantageous Effects

According to the electric vehicle according to one embodiment of the present invention, since the main motor maintains the relatively lower rotation during traveling at a high speed, it is possible to prevent energy efficiency from being sharply reduced upon traveling at a high speed.

In addition, it is possible to secure the acceleration force by the driving force generated by the sub-motor.

In addition, since power may be generated through the sub-motor, it is possible to eventually minimize energy consumption during traveling.

In addition, by appropriately varying the gear ratio of the gear unit according to the surrounding environment, it is possible to maximize energy efficiency.

### DESCRIPTION OF DRAWINGS

FIG. 1 is an exemplary view of an electric vehicle according to one embodiment of the present invention.

### MODE FOR INVENTION

Hereinafter, an electric vehicle according to one embodiment of the present invention will be described with reference to the accompanying drawings.

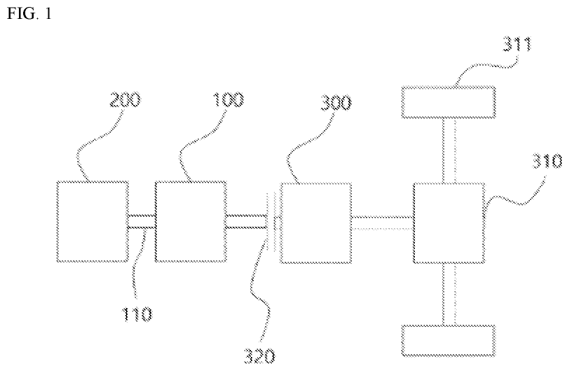

As illustrated in FIG. 1, the electric vehicle according to one embodiment of the present invention includes a main motor 100 for generating a driving force, one or more sub-motors 200 for sharing a rotational shaft 110 with the main motor 100, a gear unit 300 positioned between a differential gear 310 provided on a driving shaft and the main motor 100, and a control unit for controlling powers applied to the main motor 100 and the sub-motor 200 and varying a gear ratio of the gear unit 300.

The main motor 100 has fixed power applied after operated. The gear ratio of the gear unit 300 varies depending on an accelerator pedal manipulation, a change in speed, and an inclination of the ground. The power applied to the sub-motor 200 varies depending on the change in speed and the inclination of the ground. The control unit receives signals from various sensors installed in the vehicle. Various sensors include a vehicle speed sensor, an inclination sensor, a pedal measurement sensor, and the like.

When the power applied to the sub-motor 200 is zero, the sub-motor 200 generates power by a rotational force of the rotational shaft 110. The control unit includes a power generation circuit for generating power using the sub-motor 200. The control unit and the power generation circuit receive signals from a battery management system (BMS) provided in the vehicle. During power generation, power is supplied to a battery from the power generation circuit for charging.

The gear unit 300 has a gear ratio that varies linearly or non-linearly. The gear unit 300 may be provided in a continuously variable transmission (CVT) structure so that the gear ratio may vary non-linearly. A clutch 320 is provided between the gear unit 300 and the main motor 100. Depending on a traveling situation, the clutch 320 may be operated to disconnect the transmission of the driving force.

According to the electric vehicle according to one embodiment of the present invention, even when a driving wheel 311 rotates at a high revolutions per minute (RPM) during traveling at a high speed, the main motor 100 is not operated at a high RPM. As a result, since the main motor 100 maintains a relatively lower rotation during traveling at a high speed, it is possible to prevent energy efficiency from being sharply reduced.

In addition, it is possible to secure the acceleration force by the driving force generated by the sub-motor 200.

In addition, since power may be generated through the sub-motor 200, it is possible to minimize energy consumption during traveling.

In addition, by appropriately varying the gear ratio of the gear unit 300 according to the surrounding environment, it is possible to eventually maximize energy efficiency.

1. An electric vehicle comprising:
a main motor configured to generate a driving force;
a sub-motor configured to share a rotational shaft with the main motor; and
a gear unit positioned between a differential gear provided on a driving shaft and the main motor,
wherein the main motor has fixed power applied after operated, and
the gear unit has a gear ratio varying depending on the manipulation of an accelerator pedal.

2. The electric vehicle of claim 1, wherein the sub-motor has applied power varying depending on a change in speed and an inclination of the ground.

3. The electric vehicle of claim 2, wherein when the power applied to the sub-motor is zero, the sub-motor generates power by a rotational force of the rotational shaft.

4. The electric vehicle of claim 1, wherein the gear unit has a gear ratio varying depending on a change in speed and an inclination of the ground.

5. The electric vehicle of claim 1, wherein the gear unit has a continuously variable transmission (CVT) structure.

6. The electric vehicle of claim 1, wherein a clutch is provided between the gear unit and the main motor.
